(19) United States
(12) Patent Application Publication
(10) Pub. No.: US 2013/0272587 A1
(43) Pub. Date: Oct. 17, 2013

(54) SYSTEM AND METHOD FOR INTERACTIVE SEGMENTATION ON MOBILE DEVICES IN A CLOUD COMPUTING ENVIRONMENT

(71) Applicants: Ruogu Fang, Ithaca, NY (US); Leo Grady, Millbrae, CA (US); Gianluca Paladini, Skillman, NJ (US)

(72) Inventors: Ruogu Fang, Ithaca, NY (US); Leo Grady, Millbrae, CA (US); Gianluca Paladini, Skillman, NJ (US)

(73) Assignee: SIEMENS CORPORATION, Iselin, NJ (US)

(21) Appl. No.: 13/816,970

(22) PCT Filed: Aug. 22, 2011
(86) PCT No.: PCT/US11/48590

§ 371 Date: Jul. 2, 2013

(30) Foreign Application Priority Data
Aug. 25, 2010 (US) 61376732

(51) Int. Cl. G06T 7/00

(52) U.S. Cl. CPC G06T 7/0012
USPC 382/128

(57) ABSTRACT

A mobile device (160) for medical image analysis is disclosed. The mobile device (160) includes a display (162), a communication module (218), a memory (204) configured to store processor-executable instructions (224) and a processor (202) in communication with the display (162), the communication module (218) and the memory (204). The processor (202) being configured to execute the processor-executable instructions (224) to implement a compression routine to generate a compressed representation of a medical image stored in the memory (204), transmit the compressed representation to a remote device (110) via the communication module (218), receive segmented results from the remote device (110), wherein the segmented results are derived from a reconstruction of the compressed representation generated at the remote device (110), and present, via the display (162), a segmented medical image based on the received segmented results.

### CROSS REFERENCE TO RELATED APPLICATIONS

This patent document claims the priority benefit under 35 U.S.C. §119(e) of U.S. provisional patent application No. 61/376,732, filed on Aug. 25, 2010, titled “System and Method for Interactive Segmentation on Mobile Devices in a Cloud Computing Environment.” The entire content of the provisional patent application is incorporated by reference for all purposes.

### TECHNICAL FIELD

This patent document generally relates to a system and method for image segmentation in a distributed computing environment, and more particularly to a system and method for interactive image segmentation between a mobile computing device and a server or other remote computing resource operable in a cloud-computing environment.

### BACKGROUND

Known systems and methods for multimedia, medical imaging and communication analysis and processing require a substantial amount of processing capacity to manipulate the large amounts of data in these files and images. The intense processing requirements have precluded devices with limited processing power and memory, such as mobile computing devices, from being utilized in these applications. Thus, while mobile computing devices, such as smartphones, tablets, medical scanners and the like, are increasingly prevalent, their availability and utility in the areas of computer vision, medical imaging and computer-aided diagnostics has been limited.

Distributed networks and computing environments offer a potential solution by allowing a mobile computing device to potentially share the multimedia file, medical image and other data or information with a remote computer for processing. However, difficulties once again arise due, in this instance, to the size of the multimedia file, medical image and other data that must be transmitted between the mobile computing device and a remote computer. Specifically, the transmission speed and bandwidth requirements between the remote computer performing the processing and the mobile computing device displaying the results represent a potential bottleneck that prevents real-time interaction with the multimedia file, medical image and data of interest.

### SUMMARY

A system, method and configuration for interactive segmentation on mobile devices in a cloud-computing environment are disclosed. In one embodiment, the multimedia file, medical image or other data is compressed at the mobile computing device prior to transmission to the remote computer for further processing. The compression procedure leverages the limited onboard processing capabilities of the mobile computing device to reduce the file size and volume of the medical image or other data prior to transmission. In addition, the compression procedure may advantageously reduce the noise and redundant information present within the multimedia file, medical image or other data. For example, a medical image often encompasses a large number of pixels having zero intensity and containing high-frequency noise caused by the image acquisition process. The compression procedure may operate to remove this extraneous information prior to transmission.

The compressed image data and information are subsequently transmitted for reconstruction and processing by the remote computer or server. The processing hardware of the remote computer or server segments the reconstructed image according to an interactive image segmentation algorithm. Upon completion of the segmentation procedure, the results are transmitted back to the mobile device via either the same communication channel or through a different communication channel. The received segmentation results may then be refined at a mobile device based on an initial segment transmitted by the remote computer or server. The final, refined segmentation image may, in turn, then be displayed or provided to a user via a display or output of the mobile computing device. For example, the final refined segmentation image may be displayed via a capacitive touchscreen integral to a smartphone.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 is a general overview of a system configured to implement an interactive image segmentation process between a mobile computing device and one or more remote computing resources according to one embodiment;

FIG. 2 illustrates one embodiment of a general computer system that may be utilized in the system of FIG. 1, or other distributed systems for interactive image segmentation;

FIG. 3 is a logical block diagram illustrating one embodiment of the distributed arrangement of an interactive image segmentation routine that may be implemented between a mobile computing device and a remote computing device; and

FIG. 4 is a flowchart illustrating the steps, functions and procedures implemented in connection with an exemplary image segmentation and processing algorithm.

### DETAILED DESCRIPTION

A system, method and configuration for distributed interactive image segmentation between a mobile device and one or more remote computing devices operable in a cloud-computing environment is disclosed. An exemplary embodiment of the disclosed system and method is configured to perform data compression and display functionality at a mobile computing device while performing the computationally intensive image segmentation process at one or more remote computing devices in communication with the mobile computing device. For example, a smart phone or tablet computer may communicate compressed medical image data to a remote or cloud-computing server via the Internet or other network for segmentation and receive the resultant segmented image data for display.

In another embodiment, the mobile computing device may be configured to receive or acquire image data from another imaging device such as a medical scanner or an accessible storage location. Alternatively, the mobile computing device may include a sensor or scanner configured to capture or otherwise generate the image data to be analyzed. The user, in turn, may highlight or mark the image data via, for example, a touch screen portion of the mobile computing device to indicate features or targets of interest. The mobile computing device may next implement a compression routine stored in software and/or hardware to compress the image data.

The compressed image data is subsequently transmitted via the Internet or other network for reconstruction and processing at the remote computing device. The computational hardware and software of the remote computer or server segments the reconstructed image data according to an interactive image segmentation algorithm. The segmentation is responsive to the indication or indications of one or more targets and regions of interest identified by the user within the image data. The results of the segmentation algorithm can be transmitted or otherwise returned to mobile device for presentation and/or manipulation by the user. The mobile device may, in one or more embodiments, implement a refinement process or algorithm based on information contained within one or more of the received segments that comprise the returned image data. The final, refined segmentation image data may then be displayed or provided to a user via, for example, a capacitive touchscreen integral to the mobile computing device.

### I. System Overview

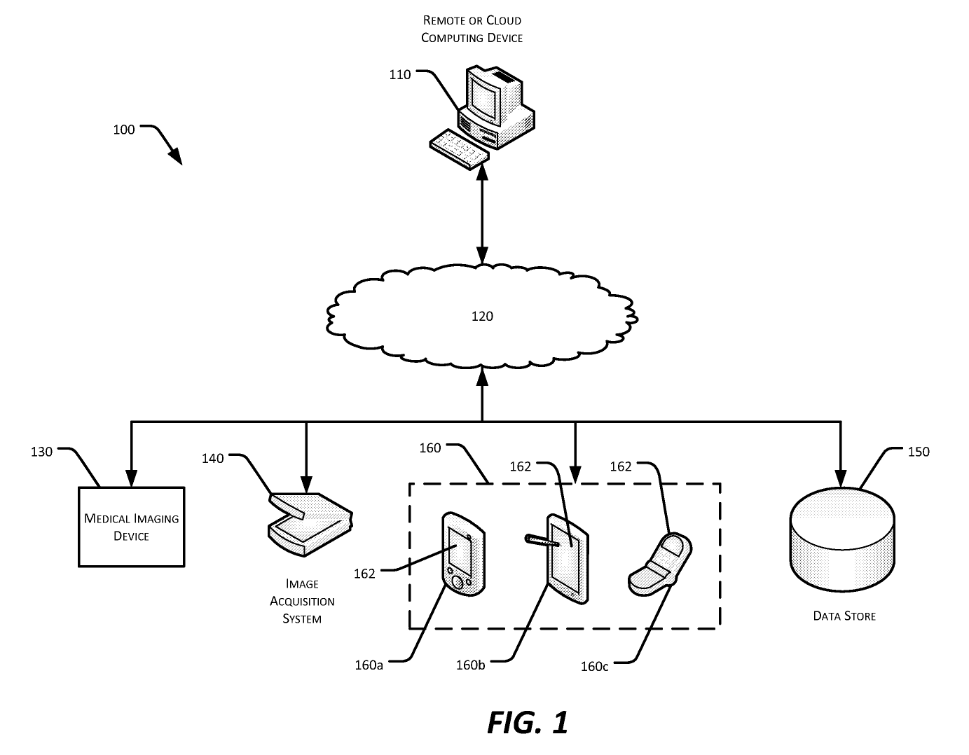

FIG. 1 provides a general overview of a system 100 for a distributed interactive image segmentation between a mobile computing device and a remote computing device operable in a cloud-computing environment. The displayed representation is intended to illustrate one possible configuration of the system 100. Other configurations can include fewer components, and in other configurations additional components may be utilized. Variations in the arrangement and type of these components may be made. These changes in configurations and components can increase or alter the capabilities of the system 100.

The exemplary system 100 includes a remote computing device 110 in communication with a network 120. The network 120 may, in turn, be coupled to and/or in communication with a medical imaging device 130, an image acquisition device 140, a data store 150, and one or more mobile computing devices 160. The remote computing device 110, in this embodiment, stores and implements processes to receive image data from one or more of the mobile computing devices 160, executes an image segmentation routine on the received image data, and transmits the segmented image data back to the one or more mobile computing devices 160 for display. The medical imaging device 130 such as a magnetic resonance imaging (MRI), computed tomography, x-ray, positron emission tomography, single photon emission computed tomography, or an ultrasound imaging system may be utilized to generate high-resolution medical images of a patient. The image acquisition device 140 may capture digital images via a charged-coupled device (CCD) or scan imaged via, for example, a flatbed scanner. The data store 150 may be a network accessible storage drive, an optical drive or any other connected medium for storing image data, such as a PACS system. The one or more mobile computing devices may include a personal digital assistant (PDA) 160a, a tablet computer 160b, a smartphone 160c, a handheld imaging system, a briefcase sized imaging system, other portable (carriable) medical system, and the like.

### A. Medical Imaging Device

The exemplary medical imaging device 130 includes any medical device or sensor capable of capturing the internal structure of an object or patient. The exemplary medical imaging device 130 may be an MRI machine, a computed tomography (CT) scanner, or an X-Ray device configured to capture image data representing the internal structure, function, or arrangement of tissue, organs and components within the patient. The medical imaging device 130 may store the generated image data locally or may communicate and store the image data in a network accessible location, such as the storage device 150. The medical imaging device 130 communicates with the remote computing device 110, the data store 150 and one or more of the mobile computing devices 160 through the network 120. The medical imaging device 130 may be in wired or wireless communication with the computing device 110, the data store 150 and one or more of the mobile computing devices 160 utilizing a universal serial bus (USB) connection, a serial connection, a Wi-Fi adaptor or other known or later developed connection scheme or protocol.

### B. Image Acquisition Device

The exemplary image acquisition device 140 includes any device capable of capturing digital image data utilizing, for example, a CCD or other imaging sensor. In another embodiment, the exemplary image acquisition device 140 may be a flatbed scanner configured to capture information contained on a fixed medium (e.g., film) and convert it into an electronic image format. In yet another embodiment, the image acquisition device 140 may be configured to receive image data from another source or location, such as from the storage device 150 or via a wired or wireless network. The image acquisition device 140 communicates with the remote computing device 110 and the data store 150 through the network 120. Alternatively, the image acquisition device 140 may bypass the network 120 and directly connect with the remote computing device 110, the data store 150 and/or the one or more mobile computing devices 160a to 160c. The image acquisition device 140 may be combined with or include elements of the computing device 110, the mobile computing devices 160 or the data store 150. The processes and systems of the medical imaging device 130 and/or the image acquisition device 140 may be one source of some or all of the noise and artifacts introduced into the image data.

### C. Data Store

The data store 150 may be operative to store image data, medical information and/or details relating to the patient as well as the patient's condition and status. The stored information and image data may include reconstructed image data, compressed image data, segmented image data, or any other data related to the system 100. The other data related to the system 100 may include identification information describing and correlating the patient to the stored image data. The data store 150 represents one or more relational databases or other data stores managed using various known database management techniques, such as, for example, SQL and object-based techniques. The data store 150 implements using one or more magnetic, optical, solid state or tape drives, or other storage mediums available now or later developed.

In this embodiment, the data store 150 is shown in communication with the computing device 110, the medical imaging device 130 and the one or more mobile computing devices 160 via the network 120. In this configuration, the data store 150 implements as a database server running MICROSOFT SQL SERVER®, ORACLE®, IBM DB2® or any other database software. The data store 150 may further be in communication with other computing devices (not shown) and servers through the network 120.

### D. Network

The network 120 may include one or more wide area networks (WAN), such as the Internet, local area networks (LAN), campus area networks, metropolitan area networks, or any other networks that may facilitate data communication. The network 120 may be divided into sub-networks that allow access to all of the other components connected to the network 120 in the system 100. Alternatively, the sub-networks may restrict access between the components connected to the network 120. The network 120 may be configured as a public or private network connection and may include, for example, a virtual private network or an encryption scheme that may be employed over the public Internet.

### E. Remote Computing Device or Server

The remote computing device 110 may be connected to the network 120 in any configuration that supports data transfer. These configurations include both wired and wireless data connections to the network 120. The remote computing device or server 110 can further run (e.g., host or serve) a web application accessible on multiple platforms that supports web content, such as a web browser or a computer, as well as the mobile computing devices 160, and/or any appliance or device capable of data communications.

The remote computing device or server 110 may include a processor, a memory, and a communication interface. For local user interaction, the remote computing device 110 may include a display and a user interface. The processor may be operatively coupled with the memory, display and the interfaces and to perform tasks at the request of the standalone application or the underlying operating system. Herein, the phrases “coupled with”, “in communication with” and “connected to” are defined to mean components arranged to directly or indirectly exchange information, data and commands through one or more intermediate components. The intermediate components may include both hardware and/or software based components.

The memory represents any hardware configuration capable of storing data. The display operatively couples to the memory and the processor in order to display information to the operator. The user interface, in turn, is stored in the memory and executed by the processor for display via the display. The user interface provides a mechanism by which an operator can interact with the system, program and algorithm. The system and method for interactive image segmentation is highly adaptable and configurable. The flexible nature of the disclosed system and method allow for a wide variety of implementations and uses for the discussed and disclosed technology and algorithms.

Herein, the phrase “operatively coupled” is defined to mean two or more devices configured to communicate and/or share resources or information either directly or indirectly through one or more intermediate components. A communication interface may be operatively coupled with the memory and the processor, and may be capable of communicating through the network 120 with the medical imaging device 130, the image acquisition device 140, the data store 150 and/or one or more mobile computing devices 160. Standalone applications may be programmed in any programming language that supports communication protocols. Examples of these languages include: SUN JAVA®, C++, C#, ASP, SUN JAVASCRIPT®, asynchronous SUN JAVASCRIPT®, or ADOBE FLASH ACTIONSCRIPT®, amongst others.

### F. Mobile Computing Devices

The mobile computing devices 160 may be any mobile device that has a data connection and includes a processor and a memory configured to implement an application. The application may be a mobile application or other processor-executable program instructions for analyzing, compressing, manipulating and/or segmenting image data. The data connection may be a cellular connection, a wireless data connection, an ethernet connection, an infrared connection, a Bluetooth connection, or any other connection capable of transmitting and/or receiving data. The mobile computing devices 160, as previously discussed, may include the personal digital assistant (PDA) 160a, the tablet computer 160b and the smartphone 160c. In one embodiment, the mobile computing device 160 may be an iPhone® available from Apple, Inc. that utilizes the iOS operating system, or a Galaxy Tab 10.1® from Samsung Electronics Co., Ltd. that utilizes the Android™ operating system.

The mobile computing devices 160 may be configured to exchange image data and information between, for example, the medical imaging device 130, the data store 150, and the remote computing device 110. In another embodiment, the mobile computing device 160 may include or be coupled to a scanner or sensor to gather image data and other related information. The mobile computing devices 160 may further include a display such as a touchscreen to present information to and receive commands from a user.

### G. Computing System Layout

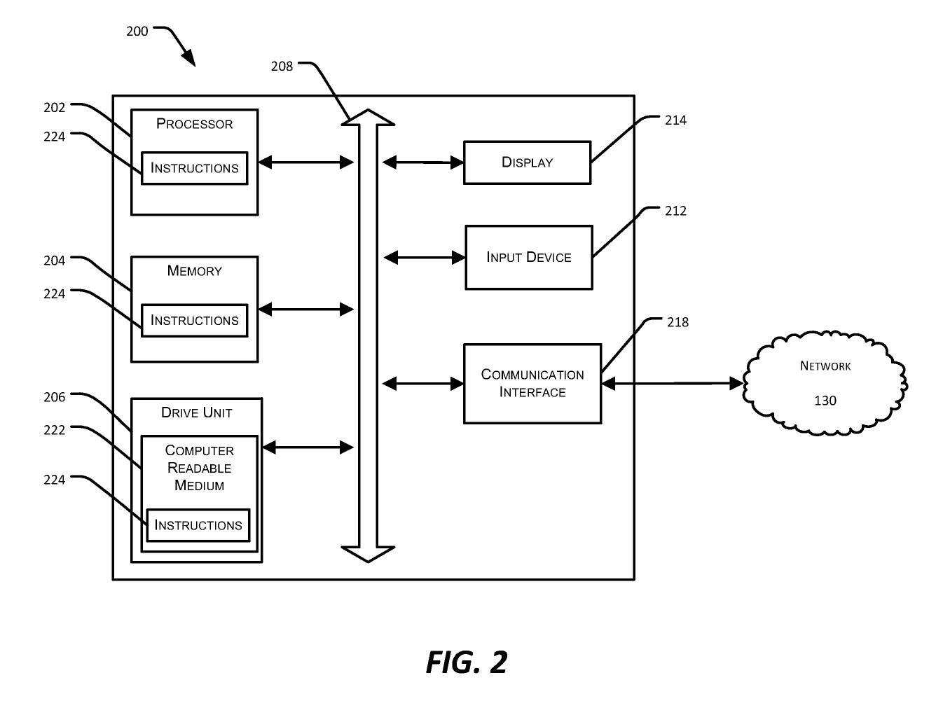

FIG. 2 illustrates a layout and configuration for a generalized computer system 200 such as the computing device 110, the PDA 160a, the tablet computer 160b, the smartphone 160c or any of the other computing devices referenced herein. Additional, different, or fewer components may be provided for any specific computing device. The computer system 200 stores and executes algorithms and processor-executable instructions 224 to cause the performance of any one or more of the methods or computer based functions discussed and disclosed herein. The computer system 200 may operate as a standalone device or may be connected to other computer systems or peripheral devices.

In a networked deployment, the computer system 200 may operate as a server or a client computer in a server-client network environment, or as a peer computer system in a peer-to-peer (or distributed) network environment. The computer system 200 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing the processor-executable instructions 224 (sequential or otherwise) that specify actions to be taken by that machine. In a particular embodiment, the computer system 200 may be implemented using electronic devices that provide voice, video and/or data communication. Further, while a single computer system 200 may be illustrated, the term “system” shall also be taken to include any collection of systems or sub-systems that individually or jointly execute a set, or multiple sets, of processor-executable instructions to perform one or more functions via the network 130.

As illustrated in FIG. 2, the computer system 200 includes a processor 202, such as, a central processing unit (CPU), a graphics-processing unit (GPU), or both. The processor 202 may be a component in a variety of systems. For example, the processor 202 may be part of a standard personal computer or a workstation. The processor hardware may incorporate one or more general processors, digital signal processors, application specific integrated circuits, field programmable gate arrays, servers, networks, digital circuits, analog circuits, combinations thereof, or other now known or later developed devices for analyzing and processing data.

The computer system 200 may include a memory 204 that can communicate via a bus 208. The memory 204 can be divided or segmented into, for example, a main memory, a static memory, and a dynamic memory. The memory 204 includes, but is not be limited to, non-transitory computer readable storage media and various types of volatile and non-volatile storage media such as: random access memory; read-only memory; programmable read-only memory; electrically programmable read-only memory; electrically erasable read-only memory; flash memory; magnetic tape or disk; optical media and the like. In one case, the memory 204 includes a cache or random access memory for the processor 202. Alternatively, or in addition to, the memory 204 may be system memory that is separated and/or distinct from the processor 202.

The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is configured to store processor-executable instructions 224 utilizable by the processor 202. The functions, acts or tasks illustrated in the figures or described herein may be performed by the programmed processor 202 executing the instructions 224 stored in the memory 204. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 200 may further include a display driver 214 configured to control the output of a touchscreen, a liquid crystal display (LCD), an organic light emitting diode (OLED), a flat panel display, a solid state display, a cathode ray tube (CRT), a projector, a printer or other now known or later developed display device for outputting determined information. The display driver 214 acts as an interface between, for example, the display 162 and the processor 202 that allows the interaction with the software (including the processor-executable instructions 224) stored in the memory 204 or in the drive unit 206.

The computer system 200 further includes an input device 212 configured to allow a user to interact with any of the components of system 200. The input device 212 may be a number pad, a keyboard, or a cursor control device, such as a mouse, or a joystick, touch screen display, remote control or any other device operative to interact with the system 200.

The computer system 200, in other embodiments, includes a disk or optical drive unit 206 to accessibly interpret computer-readable medium 222 on which software embodying algorithms or processor-executable instructions 224 are embedded. The algorithms or processor-executable instructions 224 perform one or more of the methods or logic as described herein. The instructions 224 may reside completely, or at least partially, within the memory 204 and/or within the processor 202 during execution by the computer system 200. The memory 204 and the processor 202 also may include other forms or configurations of computer-readable media as discussed above.

The computer-readable medium 222 may include processor-executable instructions 224 or receive instructions 224 responsive to a propagated signal; so that a device connected to a network 120 may communicate voice, video, audio, images or any other data over the network 120. Further, the processor-executable instructions 224 may be transmitted or received over the network 120 via a communication interface 218. The communication interface 218 may be implemented in software or may be a physical connection in hardware. The communication interface 218 provides a connection with the network 120, external media, the display 214, or any other components in system 200 or combinations thereof. In one embodiment, the connection with the network 120 is a physical connection such as a wired Ethernet connection or may be established wirelessly such as via a cellular telephone network (GSM, CDMA), an 802.11 (WiFi), 802.16 (WiMax), 802.20 (mobile broadband), 802.15 (ZigBee) and/or Bluetooth networks. The network 120 in other embodiments can be a public network, such as the Internet, a private network, such as an intranet, or combinations thereof, and may utilize a variety of networking protocols now available or later developed including, but not limited to TCP/IP based networking protocols.

The computer-readable medium 222 may be a single medium or may comprise multiple mediums such as a centralized or distributed database and/or associated caches and servers that store one or more sets of instructions. The term “computer-readable medium” is generally utilized to describe any medium that may be capable of storing, encoding or carrying an algorithm or set of instructions for execution by a processor or that may cause a computer system to perform any one or more of the methods or operations disclosed herein.

The computer-readable medium 222 may include a solid-state memory such as a memory card or other package that houses one or more non-volatile read-only memories. The computer-readable medium 222 further includes or encompasses random access memory or other volatile re-writable memory. Additionally, the computer-readable medium 222 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may use a tangible storage medium. The present disclosure may be considered to include any one or more of a computer-readable medium or a distribution medium and other equivalents and successor media, in which data or instructions may be stored.

In other embodiments, dedicated hardware implementations, such as application specific integrated circuits (ASIC), programmable logic arrays and other hardware devices, may be constructed to implement one or more of the methods described herein. Applications that include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

### II. Distributed Interactive Image Segmentation

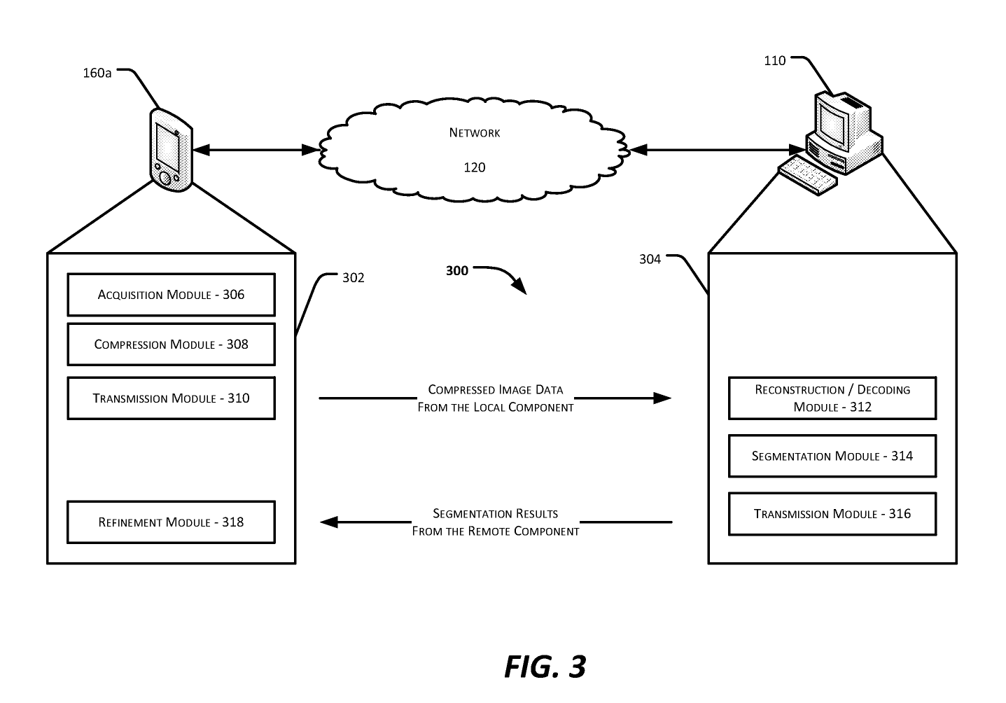

FIG. 3 is a block diagram representing a distributed interactive image segmentation routine 300 that may be executed between one of the mobile computing devices 160 and the remote computing device 110. In particular, the distributed interactive image segmentation routine 300 includes components, subroutines and modules of processor-executable instructions 224 encoded and/or stored on the computer readable medium 222 resident in memories 204 of both the mobile computing device 160 and the remote computing device 110. While the remote computing device 110 and the mobile computing device 160 may include and incorporate common elements and components of the exemplary computer system 200 (shown in FIG. 2), the capabilities and processing power of these elements and components differ greatly between these two devices. For example, the mobile computing device 160 may incorporate a low voltage variant of the processor 202 in order to maximize battery endurance. The remote computing device 110, by way of contrast, may incorporate one or more multicore processors 202 or may represent a cluster of computing devices and processors 202 tasked to implement one or more computationally intensive components, modules or routines of the interactive image segmentation routine 300.

The interactive image segmentation routine 300 is a distributed process that executes and performs discrete tasks and functions between the mobile computing device 160 and the remote computing device 110. For example, the interactive image segmentation routine 300 includes a local component 302 stored and operable on the mobile computing device 160. In the illustrated example of FIG. 3, the mobile computing device 160 is the personal digital assistant 160a configured to store the local component 302 in the local memory 204 of the device. The interactive image segmentation routine 300 further includes a remote or cloud component 304 stored and operable within the memory 204 of one or more cloud or remote computing devices 110 in communication with the personal digital assistant 160a via the Internet or network 120.

The local component 302 includes an acquisition module or subroutine 306. The acquisition module or subroutine 306 is configured to acquire, capture and store image data to be processed in the local memory 204. For example, the acquisition module 306 may query and receive image data from the data store 150. The image data may have been generated by the medical imaging device 130, the image acquisition system 140 or otherwise loaded and/or stored within the data store 150. As another example, the acquisition module 306 may receive, via query or push, image data from the medical imaging device 130 or the image acquisition system 140. Alternatively, the acquisition module 306 may receive and store the image data from a camera or sensor (not shown) integral to the personal digital assistant 160a.

The received image data may next be marked or highlighted to identify targets and/or features of interest. The image is displayed on the mobile device 160a. The user interacts with the image to designate a location or region of interest using the user interface, such as a touchscreen. Alternatively, the marking or highlighting is provided with the uploaded image data. In this way, the user interacts with and focuses the processing attention of the image segmentation routine 300 and specifically the segmentation module 314 operable within the remote computing device 110.

Once the image data and/or information has been prepared for analysis, it can be passed from the acquisition module or subroutine 304 to a compression module 308 configured to execute on the personal digital assistant 160a. The compression module 308 can be processor executable instructions 224 stored in the local memory 204 of the personal digital assistant 160a, or may be programmed or embodied on an ASIC (not shown) configured to store and implement one or more compression routines such as a JPEG compression routine, an edge-weight compression routine or known or later developed compression techniques and routines. The exemplary compression routine may be advantageously used to reduce and limit the noise and other extraneous information within the stored image data.

At this point, the stored image data has been filtered to remove the noise and reduced in size for transmission. The compressed image data can be communicated by a transmission module 310 and the communication interface 218 to the remote computing device 110 via of the network 120. The remote computing device 110 may, in one embodiment, represent a cloud computing resource such as a server or cluster of servers configured to implement and accessibly share information and computational resources via the Internet. Alternatively, the remote computing device 110 and the personal digital assistant 160a can be configured in a client-server arrangement operable within, for example, in a local network or intranet.

The compressed image data may be received by a reconstruction/decoding module 312 operable within the remote or cloud component 304. The reconstruction/decoding module 312 decodes or otherwise uncompresses the received compressed image data to generate reconstructed image data representative of the original image data captured by the acquisition module 306.

Once the received image data has been reconstructed and decoded by the reconstruction module 312, the reconstructed image data next passes to the segmentation module 314. The segmentation module 314 leverages the computational capacity of the processor or processors 202 operable within the remote computing device 110 to implement an interactive segmentation algorithm, such as a Random Walker image segmentation algorithm, a Graph Cuts image segmentation algorithm or a Shortest Path image segmentation.

The results from the segmentation process can, in turn, be communicated by a transmission module 316 and communication interface 218 operable within the remote computing device 110 back to the mobile computing device via the network 120. Communications to and from the transmission modules 310, 316 may be accomplished utilizing the same communication channel such as, for example, a wireless communication channel. Alternatively, the communication of data and information between the local component 302 and the remote component 304 may be accomplished utilizing a first communication channel such as a wireless communication channel, while communication between the remote component 304 and the local component 302 may be accomplished with utilizing a second communication channel such as a wired communication channel.

The segmented image data may be received at the communication interface 218 operable within the mobile computing device 160a and passed or provided to a refinement module 318. The refinement module 318, in an exemplary embodiment, implements a second segmentation algorithm to refine and optimize the received segmented image data. The second segmentation algorithm may be a continuation of the segmentation algorithm implemented by the segmentation module 314. For example, the refinement module 318 may utilize an initialization or initial condition provided by the segmentation algorithm implemented by the segmentation module 314 to initialize a conjugate gradient solver that computes a refined Random Walker solution. In this way, the mobile computing device 160a can locally refine and optimize the full resolution image constructed from the received segmented image data. The final optimized segmentation may be communicated to the display driver 214 and projected or displayed on the display or touchscreen 162 for use and/or further interaction by the user. The final optimized segmentation may be displayed or provided to highlight or draw attention to the interactively selected region of interest. For example, the specific feature or region of interest may be displayed in different ways such as, for example, by outlining the specific feature, by shading or coloring the region of interest differently than the background, and/or by removing the background pixels to further highlight the specific feature or region of interest.

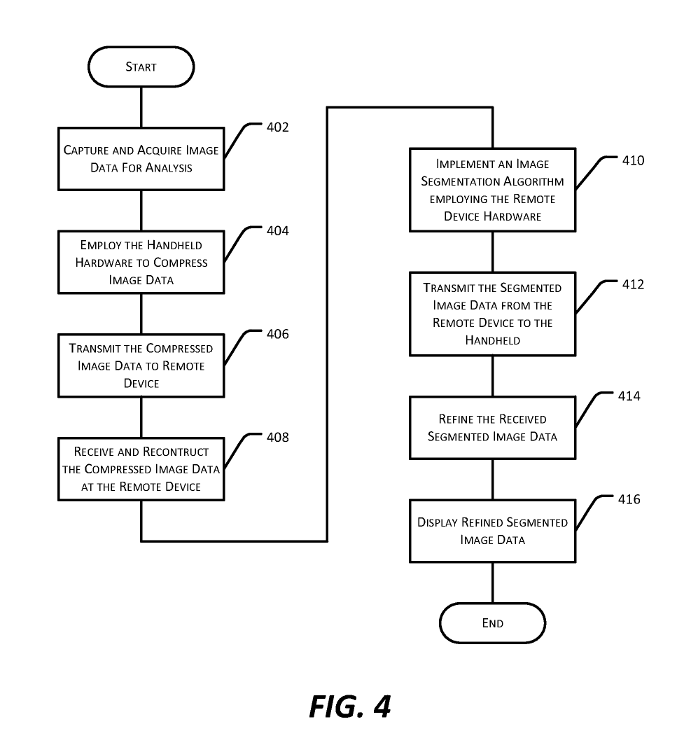

FIG. 4 depicts a flowchart 400 of another embodiment of the distributed interactive image segmentation routine 300 that may be implemented in accordance with the teaching and disclosure presented herein. The distributed interactive image segmentation process initiates by capturing image data for analysis (402). The image data may be two-dimensional, three-dimensional and four-dimensional image data representing a medical image or other image of interest. The image data may, in one embodiment, be captured using a camera or sensor component of, or coupled to, a handheld device or smartphone. In another embodiment, a medical imaging device 130 or other image acquisition device 140 may capture and store the image data in the data store 150 for subsequent use or analysis. Alternatively, the image data may be provided directly to the handheld device or smartphone via a wired or wireless network or other communication channel.

The handheld device or smartphone may, upon capturing or accessing the image data, implement a compression algorithm to generate a compressed representation of a medical image (404). The image data may be analyzed utilizing the processor 202 and memory 204 available to the handheld. The compression algorithm may be based on, for example, discrete cosine transform (DCT) encoding, block discrete cosine transform (BDCT) encoding, a Haar wavelet transformation, a Daubechies wavelet transformation, a Cohen-Daubechies-Feauveau wavelet transformation, graph weights compression and imaginary boundaries compression. In another embodiment, the compression algorithm may be a commonly used lossy compression algorithm such as Joint Photographic Experts Group (JPEG) compression. The image data may, in turn, be compressed at, for example, a 10:1 compression ratio and even a 100:1 compression ratio without significantly degrading the quality of the image data to be analyzed. As previously discussed, the process of image compression further operates to remove unwanted noise and information from the image data by filtering out the null data and extraneous high frequency noise and information that may be present due to the image capture process.

The resulting compressed image data can be transmitted from the handheld device to a remote computing device or cloud server via the network 120 without experiencing transmission lags or bottlenecks due to the large size of the image data (406). In this way, the image data can be communicated according to a variety of communication protocols including, but not limited to: GSM, CDMA, IEEE 802.11 (WiFi), IEEE 802.16 (WiMax), IEEE 802.15.4 (ZigBee), 802.20 (mobile broadband) and Bluetooth. Moreover, as compression algorithms and techniques improve and evolve image data with greater complexity and size may be communicated in this manner. The received compressed image data may, in turn, be uncompressed or decoded at the remote computing device or cloud server utilizing the same compression algorithm implemented at the handheld device (408).

Once the remote computing device reconstructs the image data from the compressed image data, an image segmentation algorithm stored in the memory 204 of the remote device may be executed by the processor 202 (410). The image segmentation algorithm generates a plurality of segmented image results utilizing a segmentation algorithm based on the Random Walker algorithm, the Graph Cuts algorithm or the Shortest Path algorithm. The resulting segmented image data can next be transmitted back to the handheld device via communication protocols and network discussed above (412). Alternatively, the remote device can utilize a compression algorithm to encode the segmented image data prior to transmission to the handheld device. Moreover, the remote device may transmit the segmented image data to the handheld device utilizing a communication protocol that may be different than the communication protocol used for the original transmission. In this way, the system and process may adapt to changes in the network environment and conditions.

The handheld device, upon receiving the segmented image data, can implement and utilize the same segmentation algorithm or other techniques to refine and/or optimize the received plurality of segmented results (414). For example, the handheld may utilize an initial segmentation provided by the remote device to quickly refine the image data prior to presentation via the display 162 (416).

While the system, method and configuration for distributed interactive image segmentation between a mobile device and one or more remote computing devices operable in a cloud-computing environment has been discussed in connection with medical imaging and medical imaging devices, these examples are intended to illustrate the inventive concepts of the present disclosure. These concepts and techniques can be utilized in a wide variety of distributed processing and imaging applications. In particular, the concepts and configuration disclosed herein may be utilized in any image and/or data processing application to leverage the processing power of one or more remote or cloud computing devices in order to display and manipulate data on a mobile or portable device in communication with at least one of the remote or cloud computing devices.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A mobile device comprising:
a display;
a communication module;
a memory configured to store processor-executable instructions;
a processor in communication with the display, the communication module and the memory, wherein the processor is configured to execute the processor-executable instructions to:
implement a JPEG compression routine to generate a compressed representation of a medical image stored in the memory;
transmit the compressed representation to a remote device via the communication module;
receive segmented data from the remote device, wherein the segmented data are derived from a decompression of the compressed representation generated at the remote device; and
present, via the display, a segmented medical image refined from the received segmented data.

2. The mobile device of claim 1, wherein the display is a touchscreen.

3. The mobile device of claim 1, wherein the communication module is configured to operate according from a communication protocol selected from the group consisting of: GSM, CDMA, IEEE 802.11 (WiFi), IEEE 802.16 (WiMax), IEEE 802.15.4 (ZigBee), IEEE 802.20 (mobile broadband) and Bluetooth.

4. The mobile device of claim 1 wherein the communication module is configured to communicate via a network, and the remote device comprises a cloud-based server.

5. The mobile device of claim 2, wherein the processor-executable instructions are further configured to:
highlight a region of interest identified in the medical image stored in the memory.

6. The mobile device of claim 5, wherein the segmented results were generated at the remote device based on a random walker interactive segmentation algorithm.

7. The mobile device of claim 1, wherein the processor-executable instructions are further configured to:
refine the received segmented data for presentation via the display.

8. The mobile device of claim 7, wherein the refined segmented data include an initial segmentation that provides a basis for refinement.

9. The mobile device of claim 1 further comprising:
a sensor configured to generate medical data, wherein the medical data is representative of the medical image.

10. The mobile device of claim 1, wherein the communication module is configured to communicate with a means for image acquisition, wherein the means for image acquisition is configured to capture the medical image.

11. A system for interactive medical image analysis between devices, the system comprising:
a mobile device including a display, a communication module and a memory configured to store processor-executable instructions, the mobile device comprising:
a processor in communication with the display, the communication module and the memory, wherein the processor is configured to execute the processor-executable instructions to:
generate a compressed representation of a medical image stored in the memory utilizing a compression algorithm;
communicate the compressed representation to a network via the communication module;
a remote device communicatively coupled to the mobile device via the network and the communication module, wherein the remote device stores and implements processor-executable instructions to:
receive the compressed representation generated by the mobile device via the network;
decompress the received compressed representation of the medical image;
implement a segmentation algorithm to generate segmented data based on the reconstructed medical image; and
communicate the plurality of segmented results back to the mobile device for presentation.

12. The system of claim 11, wherein the mobile device includes processor-executable instruction further configured to:
refine the received segmented data prior to presentation via the display.

13. The system of claim 11 further comprising:
an image acquisition device configured to capture medical image data for storage in a data store.

14. The system of claim 13, wherein the data store is the memory within the mobile device.

15. The system of claim 11, wherein the mobile device further comprises:
a sensor configured to generate medical data, wherein the medical image is representative of the medical data.

16. The system of claim 11, wherein the compression algorithm is selected from the group consisting of: discrete cosine transform encoding; a block discrete cosine transform encoding; Haar wavelet transformation; Daubechies wavelet transformation; Cohen-Daubechies-Feauveau wavelet transformation; graph weights compression and imaginary boundaries compression.

17. The system of claim 11, wherein the segmentation algorithm is selected from the group consisting of: Random Walker algorithm; Graph Cuts algorithm and Shortest Path algorithm.

18. The system of claim 11, wherein the network is the Internet and the remote device comprises a cloud-based server.

19. A method for interactive image analysis between remote devices, the method comprising:
receiving, via a network, a compressed representation of an image at a remote device, wherein the compressed representation is generated at a mobile device;
decompressing the received compressed representation of the image at the remote device;
implementing a segmentation algorithm on the remote device to generate segmented data based on the reconstructed image; and
transmitting the segmented data back to the mobile device via the network.

20. The method of claim 19 further comprising:
acquiring an image; and
storing the image in an accessible memory location.

21. The method of claim 20, wherein the accessible memory location is a memory location within a mobile device.

22. The method of claim 19, wherein implementing a compression algorithm includes implementing a compression algorithm selected from the group consisting of: discrete cosine transform encoding; a block discrete cosine transform encoding; Haar wavelet transformation; Daubechies wavelet transformation; Cohen-Daubechies-Feauveau wavelet transformation; graph weights compression and imaginary boundaries compression.

23. The method of claim 19, wherein implementing a segmentation algorithm includes implementing a segmentation algorithm selected from the group consisting of: Random Walker algorithm; Graph Cuts algorithm and Shortest Path algorithm.

24. The method of claim 19 further comprising:
presenting a segmented image based on the segmented data via a display.

25. The method of claim 19 further comprising:
refining segmented data for presentation via the display.

26. The method of claim 19 further comprising:
capturing medical data via a medical sensor coupled to the mobile device, wherein the image is representative of the medical data.
